(19) United States
(12) Patent Application Publication
(10) Pub. No.: US 2019/0356789 A1
(43) Pub. Date: Nov. 21, 2019

(54) IMAGE PROCESSING APPARATUS, IMAGE PROCESSING SYSTEM, AND PROGRAM

(71) Applicant: Konica Minolta, Inc., Tokyo (JP)

(72) Inventor: Makoto Oki, Tokyo (JP)

(73) Assignee: Konica Minolta, Inc., Tokyo (JP)

(21) Appl. No.: 16/394,885

(22) Filed: Apr. 25, 2019

(30) Foreign Application Priority Data
May 18, 2018 (JP) 2018-096320

(51) Int. Cl. H04N 1/00; G06F 9/30; H04N 1/32; G06T 7/11; G06K 9/32

(52) U.S. Cl. CPC H04N 1/00167; G06F 9/3004; H04N 1/00588; G06K 9/3233; H04N 1/32267; H04N 1/00798; G06T 7/11; H04N 1/00591

(57) ABSTRACT

An image processing apparatus includes: an image processor; and a hardware processor that converts a read image, obtained by optically reading printed paper, into a file by performing image processing. A content of the image processing, including position adjustment or gradation adjustment, is changed in accordance with an analysis result obtained by analyzing the read image.

The entire disclosure of Japanese patent Application No. 2018-096320, filed on May 18, 2018, is incorporated herein by reference in its entirety.

### TECHNOLOGICAL FIELD

The present invention relates to an image processing apparatus, an image processing system, and a program for converting an image obtained by optically reading printed paper into a file.

### BACKGROUND

Recently developed methods of detecting an abnormality of an image printed on paper by a printing apparatus include a method of detecting an abnormality by providing a scanner on a conveyance path in a subsequent stage of the printing apparatus, optically reading each piece of printed paper, and analyzing the obtained image (e.g., see JP 2013-200222 A).

In the above-described analysis, a read image obtained by reading printed paper with a scanner and a printed image printed on the paper are compared with each other to detect a difference. When the difference is equal to or greater than a specified value, the printed image is determined to be abnormal. When the printed image is determined to be abnormal, a file containing the read image and the analysis result is created and stored as a print history in order to allow a user to later recognize at which location what kind of abnormality the paper has. The print history is created not only when the printed image has an abnormality but when the printed image is normally printed. At a normal state, the print history is stored as evidence to prove that the printed image is normally printed. In a print history created at a normal state, image processing such as y conversion and background removal is performed on a read image in order to make the read image more visible to human eyes.

When a print history at an abnormal state is created by performing the same image processing as that to be performed on a read image at the time when a print history at a normal state is created, on a read image at the time when an abnormality is detected, the image processing may cause the location and state of an abnormality to be difficult to see. For example, when processing of background removal is performed on a read image determined to have abnormality due to a stain of the background, the state of the stain may become difficult to see.

One or more embodiments of the invention provide an image processing apparatus, an image processing system, and a program, which make a read image printed on paper more visible at a normal state, and, at an abnormal state, converts the read image into a file so that the state of the abnormality can be seen.

An image processing apparatus according to one or more embodiments of the present invention comprises: an input that inputs a read image obtained by optically reading printed paper with a reader and an analysis result obtained by analyzing the read image with an image analyzer that detects an abnormality of an image; an image processor; and a hardware processor that converts the read image into a file by performing image processing in which a content of position adjustment or gradation adjustment is changed in accordance with the analysis result.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 illustrates a schematic configuration of a printing system according to one or more embodiments of the invention;

FIG. 2 illustrates a configuration example of a reader of an in-line scanner unit according to one or more embodiments;

FIG. 3 is a block diagram illustrating an electrical schematic configuration of the printing system according to one or more embodiments;

FIG. 4 is a flowchart illustrating a process in which a file generator converts a read image at a normal state into a file according to one or more embodiments;

FIG. 5 is a flowchart illustrating a minimum process in which the file generator converts a read image at an abnormal state into a file according to one or more embodiments;

FIG. 6 is a flowchart illustrating processing of the file generator in a case where image processing to be performed on the read image is switched in accordance with normality/abnormality and the place of occurrence of the abnormality according to one or more embodiments;

FIG. 7 is a flowchart illustrating processing of the file generator in the case where the content of image processing to be performed on the read image is changed for each region according to one or more embodiments; and

FIG. 8 is a flowchart illustrating processing for automatically setting the content of image processing to be performed at the abnormal state according to one or more embodiments.

### DETAILED DESCRIPTION

Hereinafter, one or more embodiments of the present invention will be described with reference to the drawings. However, the scope of the invention is not limited to the disclosed embodiments.

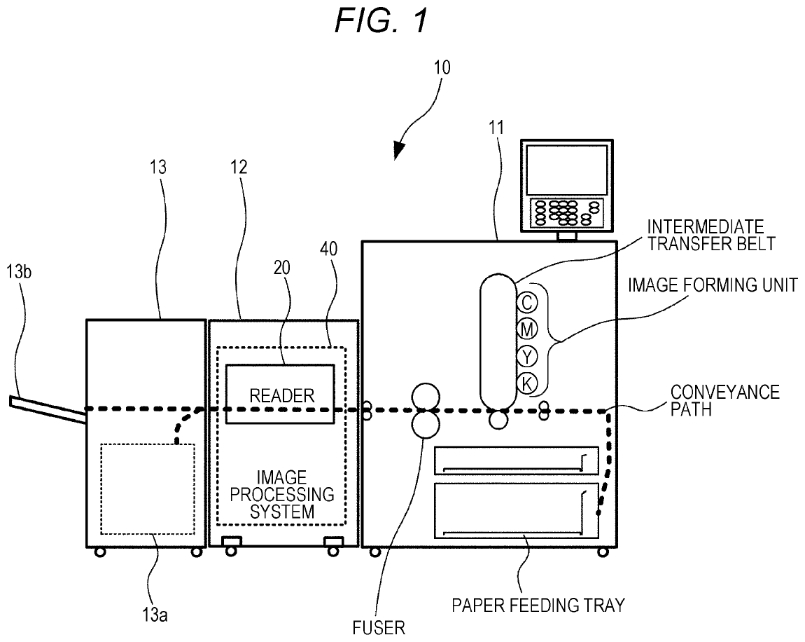

FIG. 1 illustrates a schematic configuration of a printing system 10 according to one or more embodiments of the invention. The printing system 10 includes an image forming apparatus 11, an in-line scanner unit 12, and a stacker unit 13. The image forming apparatus 11 receives print data from an external device, and forms (prints) an image on paper based on the print data to output the image. The in-line scanner unit 12 is connected to the subsequent stage of the image forming apparatus 11. The stacker unit 13 is connected to the subsequent stage of the in-line scanner unit 12.

The image forming apparatus 11 includes a wound-around endless intermediate transfer belt and image forming units for each color of C, M, Y, and K. The image forming units are disposed along the intermediate transfer belt. The image forming apparatus 11 forms a full-color toner image by superimposing toner images of each color of C, M, Y, and K on the intermediate transfer belt with the image forming units. The image forming apparatus 11 transfers the toner image formed on the intermediate transfer belt to paper that has been conveyed from a paper feeding tray, thermally fixes the toner image on the paper with a fuser, and outputs the paper to the in-line scanner unit 12 at the subsequent stage. The image forming apparatus 11 is not limited to use the tandem electrophotographic method as described above, and may adopt any method of forming an image on paper.

The in-line scanner unit 12 conveys the paper received from the image forming apparatus 11 to the stacker unit 13 at the subsequent stage of the in-line scanner unit 12. The in-line scanner unit 12 also has a function of an image processing system 40. The image processing system 40 optically reads both sides of the conveyed paper by scanning both of the sides with a reader 20, determines whether printed matter is normal/abnormal by analyzing the read image, and generates a file containing the determination result and the read image.

The stacker unit 13 ejects the paper conveyed from the in-line scanner unit 12 to either of a normal paper ejector 13a or an abnormal paper ejector 13b to stack the paper. The stacker unit 13 receives information indicating whether the paper (printed matter), which comes from the in-line scanner unit 12, is normal/abnormal from the image processing system 40. The stacker unit 13 ejects normal printed matter to the normal paper ejector 13a, and ejects abnormal printed matter to the abnormal paper ejector 13b.

Detected abnormalities include stains, streaks, and fireflies. Although the stains can appear anywhere on paper, the streaks and fireflies do not appear on the surface of blank paper, and appears only on a region where an image is formed. A firefly means an abnormality such as density unevenness appearing in a dotted shape, and a streak means an image abnormality in which fireflies appear linearly and continuously.

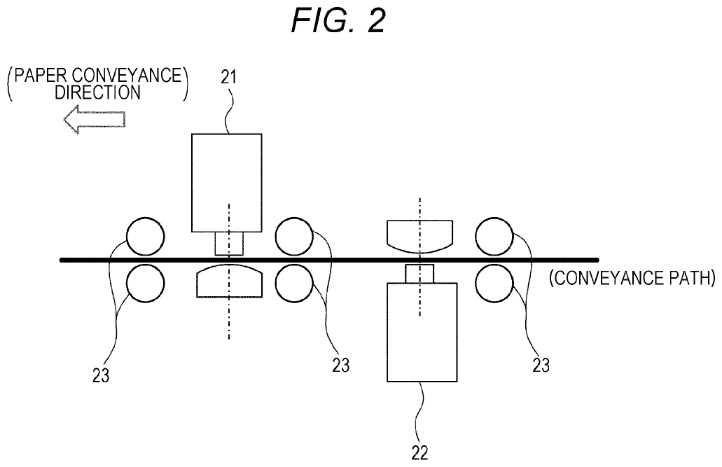

FIG. 2 illustrates a configuration example of the reader 20 of the in-line scanner unit 12 according to one or more embodiments. In order to read both sides of paper at one pass, the reader 20 includes an upper-surface-side line image sensor 21 and a lower-surface-side line image sensor 22. The upper-surface-side line image sensor 21 reads the front surface of the paper. The lower-surface-side line image sensor 22 reads the back surface of the paper. Each of the line image sensors 21 and 22 reads one line, at once, in a direction (defined as a main scanning direction) orthogonal to a paper conveyance direction that is parallel to the paper. A paper conveying mechanism for holding and conveying paper is provided at the front and back of each of the line image sensors 21 and 22. The paper conveying mechanism includes conveyance rollers 23 disposed so as to face each other.

The reader 20 two-dimensionally reads the conveyed paper by repeatedly reading the conveyed paper with the line image sensors 21 and 22, which are fixed on a conveyance path, for each line in the main scanning direction.

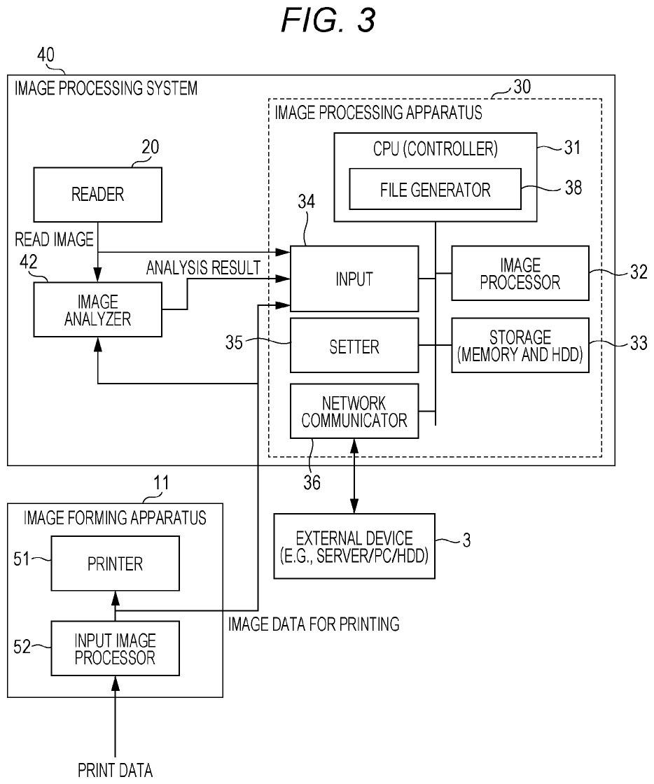

FIG. 3 is a block diagram illustrating an electrical schematic configuration of the printing system 10 according to one or more embodiments. The image forming apparatus 11 includes an input image processor 52. The input image processor 52 performs image processing (e.g., magnification conversion and gradation correction) for printing on image data obtained by processing input print data with a RIP. A printer 51 of the image forming apparatus 11 prints an image on paper based on the image data for printing output by the input image processor 52. The printer 51 includes the above-described intermediate transfer belt, the image forming unit, a fixing device, a conveyor, and a controller that controls operations of these pieces of equipment.

The image processing system 40 includes the reader 20, an image analyzer 42, and an image processing apparatus 30. The image analyzer 42 inputs image data of a read image from the reader 20, analyzes the image data, and detects abnormality of the read image.

The image processing apparatus 30 includes a CPU 31 serving as a controller. The image processing apparatus 30 also includes an image processor 32, a storage 33, an input 34, a setter 35, and a network communicator 36, which are connected to the CPU 31. The storage 33 includes a nonvolatile memory, a random access memory (RAM), and a hard disk device. The storage 33 fulfills functions of storing programs and various pieces of data and being a work memory for temporarily holding the various pieces of data at the time of executing the programs.

The input 34 inputs the image data of a read image from the reader 20 and an analysis result of the read image from the image analyzer 42. The input 34 also receives input of image data for printing corresponding to the image printed on the paper from the image forming apparatus 11. The image data for printing is also input to the image analyzer 42.

The image processor 32 performs various pieces of image processing relating to position adjustment or gradation adjustment on the image data of the read image input from the input 34. The image processor 32 has a function of performing image processing such as y conversion, filter processing, isolated point removal, color conversion, position correction, binarization processing, and image compression processing. The image processing such as the y conversion, filter processing, isolated point removal, color conversion, and binarization processing are related to the gradation adjustment.

The setter 35 fulfills a function of receiving, from a user, setting of the content and degree of image processing to be performed by the image processor 32 on the image data of the read image.

The network communicator 36 fulfills a function of communicating with various external devices (e.g., a PC, a server, and an HDD) 3 through a network such as a local area network (LAN).

The CPU 31 fulfills the function of a file generator 38 by executing a program. The file generator 38 performs conversion into a file by generating a file containing a read image and an analysis result relating to the read image from the image analyzer 42. During the conversion into a file, the file generator 38 changes a content of image processing (content of the image processing relating to the position adjustment or the gradation adjustment) to be performed by the image processor 32.

For example, when the analysis result indicates that the read image is normal (normal state), image processing such as y conversion and background removal is performed on the read image so that the read image is made more visible to human eyes. In contrast, when the analysis result indicates that the read image has an abnormality (abnormal state), the file generator 38 changes the content of the image processing from that at the normal state in order to allow the user to later recognize at which location what kind of abnormality the paper has. For example, when the paper has an abnormality of background stain, the file generator 38 changes the content of the image processing such that the background removal, which is performed at normal state, is not performed.

It should be noted that the configurations of, for example, the image processing apparatus 30 and the image processing system 40 are not limited to those illustrated in FIG. 3. For example, the CPU 31 of the image processing apparatus 30 may fulfill the functions of the image processor 32 and the image analyzer 42.

Processing of printing with the printing system 10 will now be outlined.

The image forming apparatus 11 performs printing on paper. The reader 20 of the in-line scanner unit 12 at the subsequent stage optically reads the paper. Image data of the read image obtained by the reading is input to the image analyzer 42 and the image processing apparatus 30. The image processing apparatus 30 stores the input read image in the storage 33. The image analyzer 42 analyzes the input read image to determine whether the input read image is normal as printed matter, and outputs the analysis result to the image processing apparatus 30. The image processing apparatus 30 holds the analysis result input from the image analyzer 42 in the storage 33.

The image forming apparatus 11 and the stacker unit 13 are also notified of the analysis result (normal/abnormal) of the read image. The stacker unit 13 ejects paper that is determined to be normal to the normal paper ejector 13a, and ejects paper that is determined to be abnormal to the abnormal paper ejector 13b. When an abnormality is detected, the image forming apparatus 11 performs reprinting from paper including a page that is determined to be abnormal, and automatically performs recovery. This operation allows normal printed matter to be stacked in the normal paper ejector 13a.

The file generator 38 of the image processing apparatus 30 generates a file serving as a print history from the read image and the analysis result which are stored in the storage 33. In addition to be stored in the storage 33, the generated file can be forwarded to the external device 3 such as a server through the network communicator 36. The user can browse the file by reading the file from, for example, the storage 33.

The files generated by the file generator 38 can be divided into the following two kinds. The files are classified to be stored.

(1) A file (referred to as a normal file) obtained by collecting only normal images ejected to the normal paper ejector 13a of the stacker unit 13

The normal file is directed to a print worker or a user who has requested printing, and created as evidence that printing has been performed to delivery reliably for the specified number of paper without missing a page. Image processing is performed on the read image of the normal file so that the read image is made nice in appearance and more visible.

(2) A file (referred to as an abnormal file) obtained by collecting only abnormal images ejected to the abnormal paper ejector 13b

The abnormal file is directed to, for example, a manager/worker of a printing company, and created for a reliable and easy check of at which location what kind of abnormality has occurred. The content of the image processing for the abnormal file is changed to a content different from that at the normal state in order to prevent an abnormal part such as a stain from becoming difficult to see or disappearing.

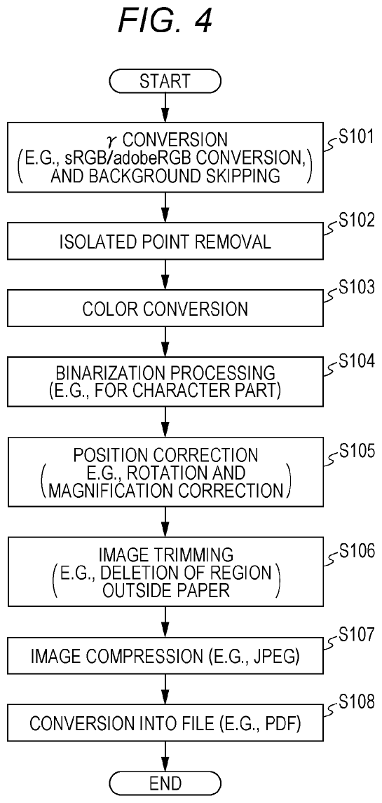

FIG. 4 is a flowchart illustrating a process in which the file generator 38 converts a read image at a normal state into a file according to one or more embodiments. At the normal state, image processing, such as y conversion (S101) for background removal, isolated point removal (S102), color conversion (S103), binarization processing (S104)(e.g., for a character part), position correction (S105) such as rotation and magnification correction, image trimming (S106) for deleting a region outside paper, and image compression (S107) is performed on image data of a read image. The file generator 38 converts the read image that has been subject to such image processing and an analysis result into a file in a file format such as a PDF (S108).

Generally, image data (RGB data) obtained by scanning with the reader 20 is dark in appearance, and has noise feeling also in a part of blank paper. In addition, tilting may occur during scanning, and the background behind paper may be reflected. Various pieces of image processing as illustrated in FIG. 4 are performed on the read image at the normal state in order to eliminate such noise since the noise is unnecessary for checking the image. The file generator 38 makes the read image more visible, and converts the read image into a file.

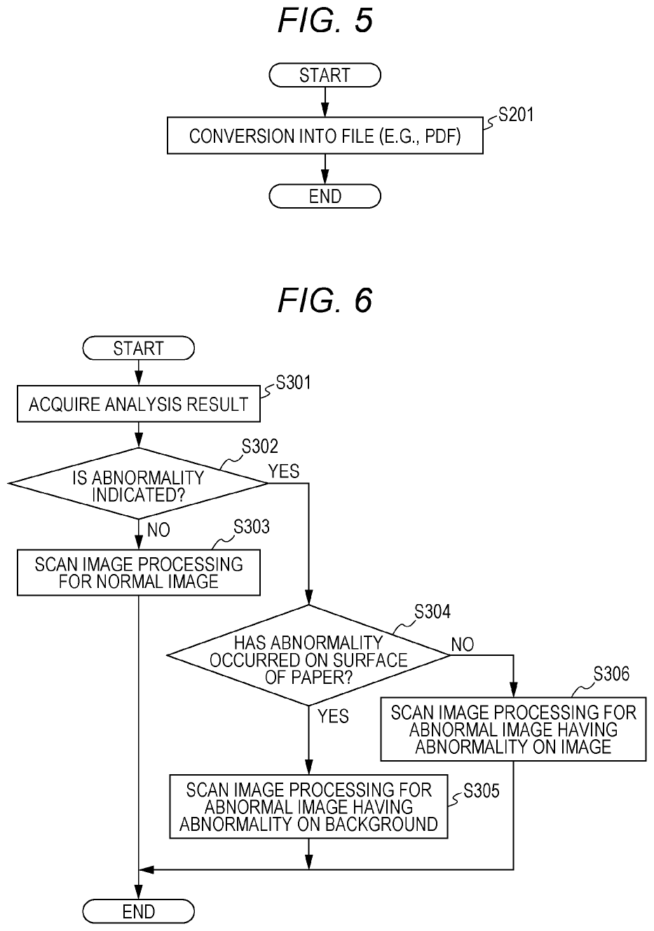

FIG. 5 is a flowchart illustrating one example of a process in which the file generator 38 converts a read image at an abnormal state into a file according to one or more embodiments. The abnormal file is used for checking the content of an abnormality. When the image processing similar to that at the normal state is performed, the abnormality may fail to be correctly checked due to disappearing or shape change of a minute abnormal image. At the abnormal state, image processing different from that at the normal state is thus performed on the read image.

FIG. 5 illustrates the simplest example of the process in which the file generator 38 converts a read image at an abnormal state into a file. In the processing of FIG. 5, all pieces of image processing that may cause blurring or disappearing of the image are eliminated in order to prevent minute stains from being deleted. The file generator 38 converts image data of the read image into a file as it is (S201). This operation causes the image to be equivalent to that at the detection of the abnormal image. The read image can be converted into a file in a state where even a subtle abnormality of image change such as a minute stain can be reliably seen.

Even at the abnormal state, a part of the image processing may be selectively performed, or the image processing may be performed while the degree (intensity) of the image processing is changed from that at the normal state. For example, reduction of a file size is required in conversion into a file. When a compression rate is increased or a resolution is lowered in order to sufficiently decrease a file size after compression compared to a file size before the compression, image quality is deteriorated. This causes an abnormality check to be difficult. Image compression processing may be performed at a compression rate lower than that at the normal state in order not to affect an abnormality check, or image processing of lowering a resolution may be performed in a range that does not affect the abnormality check.

When paper has an abnormality, deletion of a region outside the paper may be performed up to the vicinity of an edge of the paper in image trimming The trimming up to the vicinity of an edge of paper leads to reduction in file size and improvement in appearance.

In addition, when a y curve is at such a degree that the linearity of RGB is corrected, the image processing of y conversion may be performed on the read image at the abnormal state.

As described above, image processing can be performed at a set value with which the effect is diminished compared to that at the normal state.

The type or degree (intensity) of image processing to be performed on the read image at the normal/abnormal state may be set at a system side, or may be selectively set by the user.

In addition, in one or more embodiments, a set value related to the type or degree of the image processing to be performed on the read image at the abnormal state is changed in accordance with the attribute (e.g., place of occurrence, size, density, type of abnormality) of an occurred abnormality. For example, a streak sometimes occurs on a flat image. The streak does not occur on the surface of blank paper, but occurs on an image having a certain degree of density. Background removal thus may cause no problem. Consequently, the image processing is switched in accordance with the place of occurrence of the abnormality. That is, when only the image has an abnormality such as a streak, the image processing of background removal is performed. When the surface of blank paper has an image abnormality, the background removal is set not to be performed.

In addition, when the size or density of a location where an abnormality such as a firefly occurs exceeds a predetermined value, no effect may be put on a check of an abnormality state with an eye even when an image is compressed or the resolution is lowered. In contrast, when the size or density of a location of an abnormality is equal to or less than a predetermined value, the abnormality may disappear if the image is compressed or the resolution is lowered. The degrees (including with/without) of image compression or lowering a resolution may be switched in accordance with the size or density of the location where an abnormality such as a firefly occurs.

In the isolated point removal, the file generator 38 changes the setting of whether image processing of isolated point removal is performed or the setting of up to what degree of size an isolated point is removed, in accordance with the size or density of the abnormality (isolated point).

In addition, even when a background has an abnormality such as stain, the file generator 38 is not required to uniformly determine that background removal should not be performed. The file generator 38 may determine to moderately perform the background removal in a range where the stain is not disappeared in accordance with the size or density of the stain.

In one or more embodiments, when an abnormality of streak is detected, rotation processing is not performed. The streak may occur during printing, and may occur during reading owing to dirt on the reader 20. In the latter case, the streak appears at the same place. When the rotation processing is performed on the read image in which the abnormality of streak is detected, the position of the streak changes, and thus determination of whether the dirt on the reader 20 causes the streak is made impossible. When the abnormality of streak is detected, the rotation processing on the read image is prohibited.

FIG. 6 illustrates the flow of processing in the case where image processing to be performed on a read image is switched in accordance with normality/abnormality and the place of occurrence of the abnormality according to one or more embodiments. The image processing apparatus 30 acquires an analysis result of an image analysis performed on the read image by the image analyzer 42 and the read image (Step S301). When the acquired analysis result indicates normality (Step S302; No), the image processing apparatus 30 sets image processing for a normal state as the content of image processing to be performed on the read image, performs the set image processing on the read image, and generates (performs conversion into) a file containing the read image after the image processing and the analysis result (Step S303). For example, the image processing apparatus 30 performs the processing in FIG. 4.

When the analysis result indicates abnormality (Step S302; Yes), the image processing apparatus 30 determines whether the abnormality has occurred on the surface of paper or on an image (Step S304). Here, the place of an image printed in the paper can be identified based on image data for printing acquired from the image forming apparatus 11. The image processing apparatus 30 thus checks whether the abnormality has occurred on the place of the image identified from the image data for printing.

When the abnormality has occurred only on the image (Step S304; No), the image processing apparatus 30 sets image processing for the case where an abnormality has occurred on the image as image processing to be performed on the read image, performs the set image processing on the read image, and generates (performs conversion into) a file containing the read image after the image processing and the analysis result (Step S306). When the abnormality has occurred on the surface of the paper (Step S304; Yes), the image processing apparatus 30 sets image processing for the case where an abnormality has occurred on the surface of paper as the image processing to be performed on the read image, performs the set image processing on the read image, and generates (performs conversion into) a file containing the read image after the image processing and the analysis result (Step S305). In the image processing of Step S306, for example, the image processing apparatus 30 performs background removal to improve appearance. In the image processing of Step S305, the image processing apparatus 30 does not perform the background removal or moderates the degree of the background removal in order to prevent disappearing of the abnormality.

The type and degree of image processing to be performed on the read image may be changed in accordance with an image area in one page. For example, when the background is stained, γ conversion processing is performed with a γ curve that emphasizes contrast only for the stained part. The processing enables the stained part to be displayed more clearly.

It should be noted that in one or more embodiments, the image processing of, for example, emphasizing contrast is performed not only on a location of the abnormality but also on a region around the location. The partial difference of the γ curve, however, may cause a feeling of strangeness in the connection between the part and the surroundings. The content of the image processing may thus be changed in accordance with the condition of a surrounding image. For example, when not the surface of white paper but he image is stained, the emphasis processing varies the background image together with the stain. When an image is behind a stain, changes may thus be made such that the emphasis processing is performed weaklier than in the case of white background behind the stain or a region is not expanded.

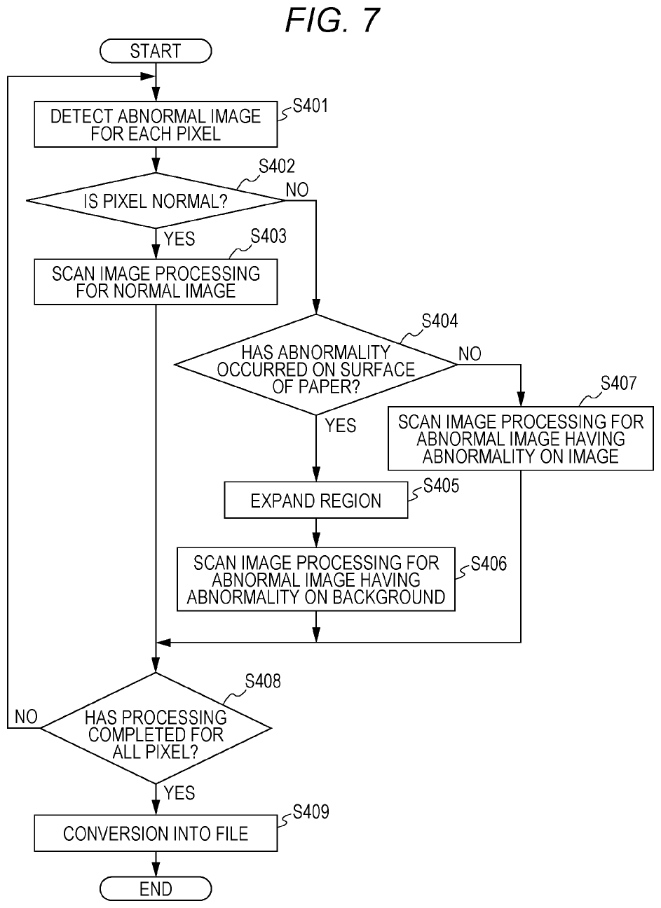

FIG. 7 illustrates processing in the case where the file generator 38 changes the content of image processing to be performed on a read image for each region according to one or more embodiments. In the process of FIG. 7, image analysis processing is performed by the image analyzer 42, while image processing for conversion into a file is concurrently performed.

The image analyzer 42 determines whether a pixel or an image in a region is normal for each region or pixel (Step S401). Here, description will be made assuming that the determination is made for each pixel. When a pixel of interest is normal (Step S402; Yes), the file generator 38 sets image processing for a normal state as image processing to be performed on the pixel, performs the set image processing on the pixel (Step S403), and transitions to Step S408.

When the pixel of interest is abnormal (Step S402; No), the file generator 38 determines whether the pixel of interest is on the surface of paper or on an image (Step S404). When the pixel of interest is on the image (Step S404; No), the file generator 38 sets image processing for the case where the abnormality has occurred on the image as image processing to be performed on the pixel, performs the set image processing on the pixel (Step S407), and transitions to Step S408.

When the pixel of interest is on the surface of paper (Step S404; Yes), the file generator 38 expands a region (Step S405), sets image processing for the case where the abnormality has occurred on the surface of the paper as image processing to be performed on each pixel in the region, performs the set image processing on each pixel in the region (Step S406), and transitions to Step S408.

In Step S408, the file generator 38 determines whether the processing has been completed for all the pixels. When the processing has not been completed (Step S408; No), the file generator 38 returns to Step S401. When the processing has been completed (Step S408; Yes), the file generator 38 converts the read image after the image processing into a file, and ends the processing.

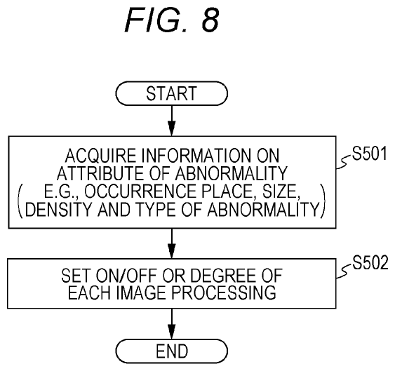

FIG. 8 is a flowchart illustrating processing in which the file generator 38 of the image processing apparatus 30 sets image processing for an abnormal state according to one or more embodiments. The file generator 38 acquires information indicating, for example, the attribute (place of occurrence (on the surface of paper, on an image, and in a region outside/inside the paper), the size of the abnormality, the density of the abnormality, and the type (a stain, a streak, and a firefly)) of the detected abnormality (Step S501), and sets the degree (including on/off) of the image processing to be performed on the read image based on the information (Step S502).

In Step S502, for example, the file generator 38 determines whether or not the image processing of each of the image processing and resolution conversion in Steps S101 to S107 of FIG. 4 is performed. When the image processing is performed, the file generator 38 determines the degree of the image processing.

Although the previously-described embodiments of the invention have been described with reference to the drawings, the specific configurations are not limited to those illustrated in the previously-described embodiments. Changes and additions without departing from the spirit of the invention are included in the invention.

Although, in the previously-described embodiments, an analysis result is converted into a file together with a read image that has been subjected to image processing, a generated file is not required to contain the analysis result. A file at a normal state may be stored in a folder for a normal state, and a file at an abnormal state may be stored in a folder for an abnormal state. The analysis results to be contained in the file desirably contains detailed information that helps a user to check the location and content of an abnormality with an image. Such detailed information includes the place of occurrence, type, size, and density of the abnormality in addition to normality/abnormality. It should be noted that the file may include other information such as the date and time of printing, identification information for a printing apparatus, and environmental information (temperature and humidity).

Although, in the previously-described embodiments, paper is optically read by the in-line scanner unit 12 connected to the subsequent stage of the image forming apparatus 11, the reader 20 is not limited to being provided on a conveyance path. The reader 20 may be an off-line scanner.

One or more embodiments of the invention may be the image processing system 40 including the reader 20 and the image analyzer 42. One or more embodiments of the invention are not required to include the reader 20 and the image analyzer 42. One or more embodiments of the invention may be the image processing apparatus 30 that receives image data or an analysis result of a read image and performs processing of conversion into a file. One or more embodiments of the invention may also be a program that causes an information processor to function as the image processing apparatus 30.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image processing apparatus comprising:
an image processor; and
a hardware processor that converts a read image, obtained by optically reading printed paper, into a file by performing image processing, wherein
a content of the image processing, comprising position adjustment or gradation adjustment, is changed in accordance with an analysis result obtained by analyzing the read image.

2. The image processing apparatus according to claim 1, wherein
the hardware processor changes a content of position adjustment or gradation adjustment for each region of the read image in accordance with the analysis result.

3. The image processing apparatus according to claim 1, wherein
the content of the image processing that is changed in accordance with the analysis result includes one or more of y conversion, filter processing, isolated point removal, color conversion, position correction, binarization processing, and image compression processing.

4. The image processing apparatus according to claim 1, wherein
when the analysis result indicates an abnormality, the hardware processor does not perform at least one piece of the image processing compared to when the analysis result indicates no abnormality.

5. The image processing apparatus according to claim 1, wherein
when the analysis result indicates an abnormality, the hardware processor changes the content of image processing to emphasize the abnormality.

6. The image processing apparatus according to claim 1, wherein
the hardware processor performs image processing on the read image in accordance with a setting, received from a user, of a degree of the change to the content of the image processing.

7. The image processing apparatus according to claim 1, wherein
when the analysis result indicates an attribute of an abnormality detected from the read image, the hardware processor switches a degree of the change to the content of the image processing in accordance with the attribute of the abnormality.

8. The image processing apparatus according to claim 1, wherein
the file contains the analysis result.

9. An image processing system comprising:
the image processing apparatus according to claim 1.

10. A non-transitory recording medium storing a computer readable program to be executed at an information processor, the program causing a computer to:
input a read image obtained by optically reading printed paper and an analysis result obtained by analyzing the read image;
change and set a content of image processing, comprising position adjustment or gradation adjustment, in accordance with the analysis result;
perform the image processing on the read image in accordance with the changed and set content of the image processing; and
convert the image processed read image into a file.

11. The non-transitory recording medium storing a computer readable program according to claim 10, wherein
a content of position adjustment or gradation adjustment is changed for each region of the read image in accordance with the analysis result.

12. The non-transitory recording medium storing a computer readable program according to claim 10, wherein
the content of the image processing that is changed in accordance with the analysis result includes one or more of y conversion, filter processing, isolated point removal, color conversion, position correction, binarization processing, and image compression processing.

13. The non-transitory recording medium storing a computer readable program according to claim 10, wherein
when the analysis result indicates an abnormality, the content of the image processing is set, while changing and setting the content of the image processing, such that at least one piece of the image processing is not performed on the read image compared to when the analysis result indicates no abnormality.

14. The non-transitory recording medium storing a computer readable program according to claim 10, wherein
when the analysis result indicates an abnormality, the content of the image processing is set, while changing and setting the content of the image processing, to emphasize the abnormality.

15. The non-transitory recording medium storing a computer readable program according to claim 10, the program causing the computer to further:
receive, from a user, a setting of a degree of the change to the content of the image processing to be performed on the read image, wherein,
the image processing is set, while changing and setting the content of the image processing, in accordance with the received setting.

16. The non-transitory recording medium storing a computer readable program according to claim 10, wherein
when the analysis result indicates an attribute of an abnormality detected from the read image, a degree of the change to the content of the image processing is switched, while changing and setting the content of the image processing, in accordance with the attribute of the abnormality.

17. The non-transitory recording medium storing a computer readable program according to claim 10, wherein
the file contains the analysis result.
